(19) United States
(12) Patent Application Publication
(10) Pub. No.: US 2013/0305089 A1
(43) Pub. Date: Nov. 14, 2013

(54) MOTHERBOARD TESTING APPARATUS AND METHOD FOR TESTING

(71) Applicants: Hong Fu Jin Precision Industry (Wu-Han) Co., Ltd., (US); HON HAI PRECISION INDUSTRY CO., LTD., New Taipei (TW)

(72) Inventor: ZHONG-GANG WU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/752,777

(22) Filed: Jan. 29, 2013

(30) Foreign Application Priority Data
May 10, 2012 (CN) 201210143452.6

(51) Int. Cl. G06F 11/273

(52) U.S. Cl. CPC G06F 11/273
USPC 714/27

(57) ABSTRACT

The present disclosure provides a motherboard testing apparatus and method. The motherboard testing method includes following steps. A motherboard testing apparatus is provided. The testing computer and the testing device are electrically connected to a motherboard. The testing computer runs an operating system based on the motherboard. The testing computer receives an input testing times and sends the input testing times and a running signal to the testing device. The testing device powers off the motherboard, reduces the input testing times by 1 to a current testing times after a period of determined time, and powers on the motherboard after determining that the current testing times is greater than 0.

### BACKGROUND

1. Technical Field

The present disclosure relates to motherboard testing apparatuses, and especially relates to a motherboard testing apparatus and method for automatically turning on and off a motherboard.

2. Description of Related Art

In computer systems such as personal computer (PC) systems, operators usually need to press a power button of the PC system to ground a sixth terminal of a computer front panel header, thereby turning on the computer system, which is inconvenient and time consuming for operators who are manually performing a motherboard test, in which it is commonly necessary to power up the motherboard about a thousand times.

Therefore there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of a motherboard testing apparatus in accordance with an embodiment.

FIG. 2 is a flow chart of a motherboard testing method in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

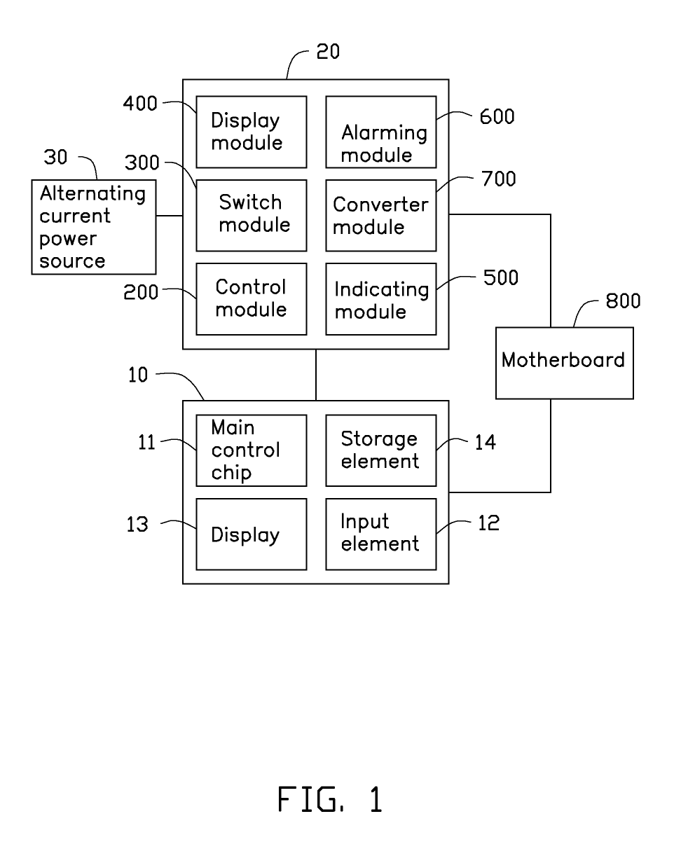

FIG. 1 is a motherboard testing apparatus of one embodiment. The motherboard testing apparatus is used for testing the power-on and power-off cycle of a motherboard 800. The motherboard testing apparatus includes a testing computer 10 and a testing device 20.

The testing computer 10 includes a main control chip 11, an input component 12, a display 13 and a storage component 14. The main control chip 11, the input component 12, the display 13, and the storage component 14 of the testing computer 10 are electronically connected to the motherboard 800 and work based on the motherboard 800. The testing device 20 includes a control module 200, a switch module 300, a display module 400, an indicating module 500, an alarm module 600, and a converter module 700. The switch module 300 is connected to an alternating current power source 30. In one embodiment, the storage component 14 is a hardware disk drive, and the input component 12 is a keyboard.

The storage component 14 stores an operating system, such as DOS system or Windows system. The operating system works based on the motherboard 800. The display 13 is configured to display the user interface of the operating system. The input component 12 is configured to input testing times to the main control chip 11 via the user interface after the testing computer 10 runs the operating system. The main control chip 11 is configured to receive the testing times and send the testing times and a running signal to the control module 200.

The display module 400, the indicating module 500, and the alarm module 600 are connected to the control module 200. The switch module 300 is connected between the control module 200 and the motherboard 800. In one embodiment, the control module 200 is control chip, the display module 400 is a liquid crystal display, the indicating module 500 is a light-emitting diode, and the alarm module 600 is a buzzer.

The control module 200 is configured to turn off the switch module 300 to power off the motherboard 800 after receiving the running signal, reduce the testing times by 1 after a predetermined time, and determine if the current testing times is greater than 0. The control module sends a power on signal to the motherboard 800 to power on the motherboard 800 after the current testing times is greater than 0. The control module 200 is further configured to display the false information on the display module 400 after the motherboard 800 is abnormally powered on or off. The indicating module 500 is configured to indicate that the motherboard 800 is powered on. The alarm module 600 is configured to sound when the motherboard 800 is abnormal.

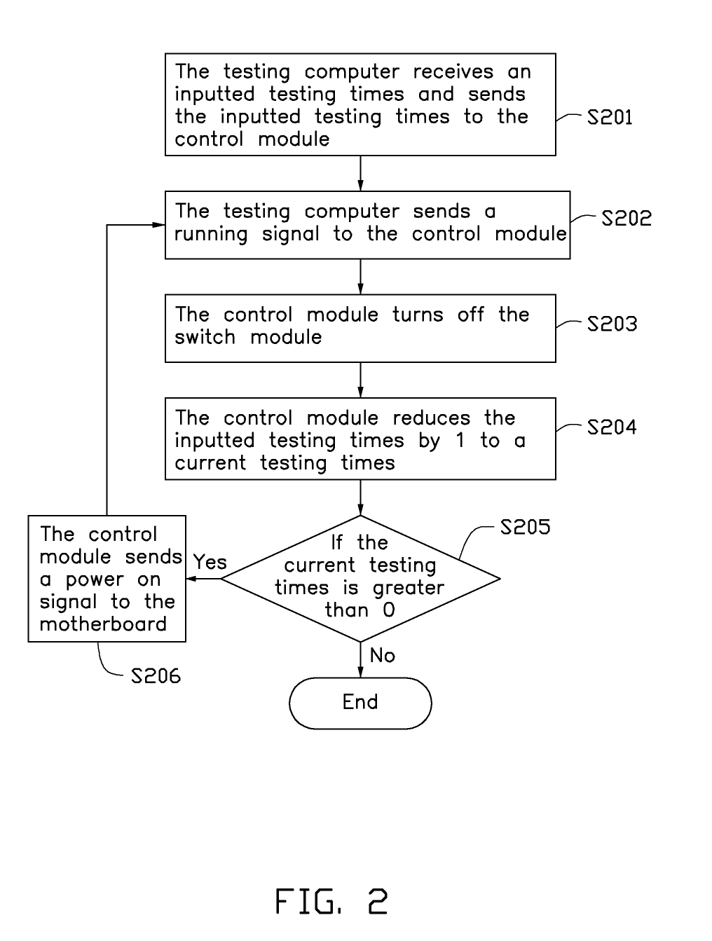

FIG. 2 shows that the motherboard testing method includes following steps.

S201, the motherboard 800 is powered on to run the operating system of the testing computer 10. The input component 12 receives the predetermined testing times input by the user. The main control chip 11 sends the predetermined testing times to the control module 200.

S202, the main control chip 11 sends a running signal to the control module 200.

S203, the control module 200 turns off the switch module 300 to power off the motherboard 800 after receiving the predetermined testing times and the running signal.

S204, the control module 200 reduces the predetermined testing times by 1 to a current testing times after a predetermined time.

S205, the control module 200 determines if the current testing times is greater than 0. If so, continues step S206, if not, the process is over.

S206, the control module 200 sends a power on signal to the motherboard 800 to power on the motherboard 800, and the process returns to the step S202.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A motherboard testing apparatus, for testing a power-on and power-off cycle of a motherboard, comprising:
a testing computer configured to be electrically connected to the motherboard, the testing computer comprising:
a storage component, the storage component is configured to store an operating system;
a display, the display is configured to display a user interface of the operating system;
an input component, the input component is configured to input a predetermined testing times via the user interface after the operating system runs; and
a main control chip;
a testing device, the testing device comprising:
a control module;
a converter module, the converter module is configured to be connected to the motherboard; and
a switch module, the switch module is connected between the control module and the converter module, and the switch module is configured to be connected to an alternating current power source;
wherein the main control chip is configured to receive the predetermined testing times, and send the predetermined testing times and a running signal, after the operating system runs, to the control module; the control module is configured to turn off the switch module to power off the motherboard after receiving the predetermined testing times and the running signal; the main control chip is further configured to reduce the predetermined testing times by 1 to a current testing times after a predetermined time is over and send a power on signal to the motherboard to power on the motherboard after determining that the current testing times is greater than 0.

2. The motherboard testing apparatus of claim 1, wherein the testing device further comprises a display module, and the control module is further configured to display false information on the display module after the motherboard is abnormally powered on or off.

3. The motherboard testing apparatus of claim 1, wherein the testing device further comprises an indicating module, and the indicating module is configured to indicate that the motherboard is powered on.

4. The motherboard testing apparatus of claim 1, wherein the testing device further comprises an alarming module, and the alarming module is configured to indicate an alarm when the motherboard is abnormally powered on or off.

5. A motherboard testing method, comprising:
providing a motherboard testing apparatus, the motherboard testing apparatus comprising a testing computer and a testing device, the testing computer and the testing device are electrically connected to a motherboard;
running an operating system in the testing computer based on the motherboard;
receiving an inputted testing times via the testing computer and sending the inputted testing times and a running signal to the testing device; and
powering off the motherboard via the testing device, reducing the inputted testing times by 1 to a current testing times after a period of determined time, powering on the motherboard after determining that the current testing times is greater than 0.

6. The motherboard testing method of claim 5, further comprising displaying false information when the motherboard is abnormally powered on or off via the testing device.

7. The motherboard testing method of claim 5, further comprising indicating that the motherboard is powered on via the testing device.

8. The motherboard testing method of claim 5, further comprising alarming when the motherboard is abnormally powered on or off via the testing device.
